(19) United States
(12) Patent Application Publication
(10) Pub. No.: US 2007/0293173 A1
(43) Pub. Date: Dec. 20, 2007

(54) Method and apparatus for data framing in a wireless communications system

(75) Inventor: Sam Shiaw-Shiang Jiang, (US)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 11/812,216

(22) Filed: Jun. 15, 2007

Related U.S. Application Data
(60) Provisional application No. 60/805,097, filed on Jun. 19, 2006.

(51) Int. Cl. H04B 1/18

(52) U.S. Cl. 455/187.1

(57) ABSTRACT

To reduce overhead in a radio link control (RLC) protocol data unit (PDU) header, when a plurality of package data convergence protocol (PDCP) protocol data units (PDU) are multiplexed into a radio link control (RLC) PDU, a first PDCP sequence number (SN) of a first PDCP PDU of the plurality of PDCP PDUs is used, and all PDCP SNs of the plurality of PDCP PDUs other than the first PDCP SN are removed from the RLC PDU.

### CROSS REFERENCE TO RELATED APPLICATIONS

This application claims the benefit of U.S. Provisional Application No. 60/805,097, filed on Jun. 19, 2006 and entitled “Method and Apparatus for Data Framing and Handling Missing Packets upon Handover in a Wireless Communications System,” the contents of which are incorporated herein by reference.

### BACKGROUND OF THE INVENTION

1. Field of the Invention

The present invention relates to data framing in wireless communications systems, and more particularly, to a method and related device for performing data framing that reduces header overhead in radio link control protocol data units.

2. Description of the Prior Art

3GPP radio-access technology is poised for continued competitiveness in years to come with such enhancements as high-speed downlink protocol access (HSDPA) and Enhanced Uplink. In the long term, competitiveness is assured through what is called a “long-term evolution” (LTE) of the 3GPP radio-access technology. According to 3GPP TR 25.813 V 0.0.1 (2006-06), “Evolved Universal Terrestrial Radio Access (E-UTRA) and Evolved Universal Terrestrial Radio Access Network (E-UTRAN) Radio Interface Protocol Aspects,” hereafter “3GPP TR 25.813,” the LTE includes important advances such as, “reduced latency, higher user data rates, optimised support for packet services, improved system capacity and coverage, and reduced cost for the operator, while also reducing system complexity.”

In acknowledged mode (AM), a radio link control (RLC) entity is split into a transmitting side and a receiving side. The transmitting side receives RLC SDUs from upper layers through an AM service access point (AM-SAP). The RLC SDUs are concatenated or segmented to AMD PDUs of a predetermined length. Then, the AMD PDUs are placed in a retransmission buffer and a MUX. The MUX multiplexes AMD PDUs from the retransmission buffer and AMD PDUs that are newly segmented/concatenated. A function then completes a header on the AMD PDUs. Then, the transmission side of the RLC entity sends the AMD PDUs to a lower layer, e.g. a medium access control (MAC) layer, through a logical channel.

In LTE, a packet data convergence protocol (PDCP) entity, which is an upper layer of RLC entity, must provide a PDCP SN for each packet, i.e. for each RLC SDU, to facilitate ciphering functionality. The RLC entity can use the PDCP SN to perform reordering, duplication detection, flow control, and ARQ. When multiple PDCP PDUs, i.e. RLC SDUs, are multiplexed or concatenated into one RLC PDU as described above, the original PDCP PDUs are fully included in the RLC PDU, i.e. contents of the original PDCP PDUs are not touched during multiplexing or concatenation. This straightforward framing method increases the length of the RLC PDU to be transmitted on radio.

### SUMMARY OF THE INVENTION

According to the present invention, a method of performing data framing in a wireless communications system when a plurality of package data convergence protocol (PDCP) protocol data units (PDU) are multiplexed into a radio link control (RLC) PDU comprises using a first PDCP sequence number (SN) of a first PDCP PDU of the plurality of PDCP PDUs, and removing all PDCP SNs of the plurality of PDCP PDUs other than the first PDCP SN from the RLC PDU.

According to the present invention, a communications device utilized in a wireless communications system for performing data framing when a plurality of package data convergence protocol (PDCP) protocol data units (PDU) are multiplexed into a radio link control (RLC) PDU comprises a control circuit for realizing functions of the communications device, a central processing unit installed in the control circuit for executing program codes to operate the control circuit, and a memory coupled to the central processing unit. The memory comprises program code executed for using a first PDCP sequence number (SN) of a first PDCP PDU of the plurality of PDCP PDUs, and program code executed for removing all PDCP SNs of the plurality of PDCP PDUs other than the first PDCP SN from the RLC PDU. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 is a flowchart of a process according to the present invention.

### DETAILED DESCRIPTION

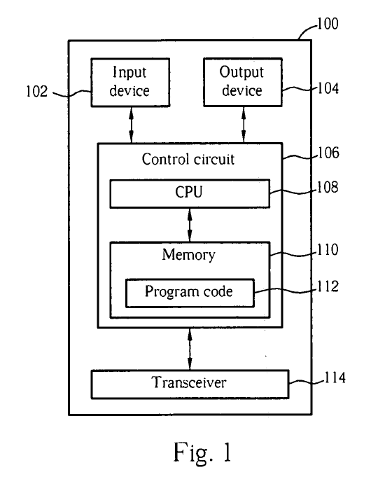

Please refer to FIG. 1, which is a function block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

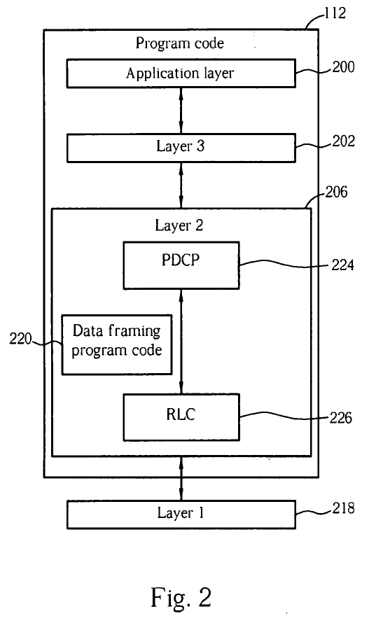

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 2 206 comprises two sub-layers: a radio link control (RLC) entity 226 and a packet data convergence protocol (PDCP) entity 224. The PDCP entity 224 is an upper layer to the RLC entity 226. Primary functions of the RLC entity 226 include providing segmentation, reassembly, concatenation, padding, retransmission, sequence check, and duplication detection on transmitted data or control instructions based on different transmission quality requirements. The PDCP entity 224 is primarily responsible for compression/decompression of headers, ciphering, transfer of user data, and maintenance of PDCP sequence numbers.

In LTE, the PDCP entity 224 must provide a PDCP SN for each packet, i.e. for each RLC SDU, to facilitate ciphering functionality. The RLC entity 226 can use the PDCP SNs when performing reordering, duplication detection, flow control, and ARQ functionalities. To decrease overhead, the program code 112 comprises a data framing program code 220.

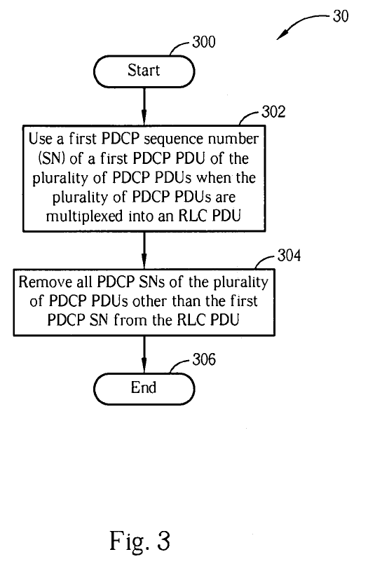

Please refer to FIG. 3, which is a flowchart of a process 30 according to an embodiment of the present invention. The process 30 is utilized for data framing in the wireless communications system, and can be complied into the data framing program code 220. The process 30 comprises the following steps:
Step 300: Start.
Step 302: Use a first PDCP sequence number (SN) of a first PDCP PDU of the plurality of PDCP PDUs when the plurality of PDCP PDUs are multiplexed into an RLC PDU.
Step 304: Remove all PDCP SNs of the plurality of PDCP PDUs other than the first PDCP SN from the RLC PDU.
Step 306: End.

According to the process 30, when the plurality of PDCP PDUs are multiplexed into the RLC PDU, only one PDCP SN of the plurality of the first PDCP PDU of the PDCP PDUs that are multiplexed is needed. The other PDCP SNs are removed from the said RLC PDU. They can be rebuilt by the peer RLC entity of the peer receiver. The PDCP SN of the first PDCP PDU of the PDCP PDUs that are multiplexed into one RLC PDU can be included in the RLC PDU. It should be noted that the first PDCP PDU is not necessarily a PDCP PDU received first, multiplexed first, or concatenated first. Any PDCP PDU in the plurality of PDCP PDUs could serve as the first PDCP PDU. Preferably, the PDCP PDU that is multiplexed first serves as the first PDCP PDU.

In summary, by removing other PDCP SNs from an RLC PDU when multiplexing the PDCP PDUs to form the RLC PDU, the present invention can reduce the overhead of the RLC PDU header and conserve wireless resources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing data framing in a wireless communications system when a plurality of package data convergence protocol (PDCP) protocol data units (PDU) are multiplexed into a radio link control (RLC) PDU, the method comprising:
using a first PDCP sequence number (SN) of a first PDCP PDU of the plurality of PDCP PDUs; and
removing all PDCP SNs of the plurality of PDCP PDUs other than the first PDCP SN from the RLC PDU.

2. The method of claim 1, wherein the PDCP SN of the first PDCP PDU of the plurality of PDCP PDUs is included in the RLC PDU.

3. A communications device utilized in a wireless communications system for performing data framing when a plurality of package data convergence protocol (PDCP) protocol data units (PDU) are multiplexed into a radio link control (RLC) PDU, the communications device comprising:
a control circuit for realizing functions of the communications device;
a central processing unit installed in the control circuit for executing program codes to operate the control circuit; and
a memory coupled to the central processing unit and comprising:
program code executed for using a first PDCP sequence number (SN) of a first PDCP PDU of the plurality of PDCP PDUs; and
program code executed for removing all PDCP SNs of the plurality of PDCP PDUs other than the first PDCP SN from the RLC PDU.

4. The communications device of claim 3, wherein the PDCP SN of the first PDCP PDU of the plurality of PDCP PDUs is included in the RLC PDU.
